(19) United States
(12) Patent Application Publication
(10) Pub. No.: US 2017/0248218 A1
(43) Pub. Date: Aug. 31, 2017

(54) STRUCTURAL MEMBER OF VEHICLE AND METHOD OF MANUFACTURING THE SAME

(71) Applicant: HONDA MOTOR CO., LTD., Tokyo (JP)

(72) Inventors: Daisuke KANEKO, Wako (JP); Yohei NOJI, Wako (JP); Yasuhiro TOGUCHI, Wako (JP); Hiroshi FUJIOKA, Wako (JP); Kenta UMETSU, Wako (JP)

(73) Assignee: HONDA MOTOR CO., LTD., Tokyo (JP)

(21) Appl. No.: 15/426,061

(22) Filed: Feb. 7, 2017

(30) Foreign Application Priority Data
Feb. 29, 2016 (JP) 2016-036547

(51) Int. Cl. F16H 53/02; B29C 45/00; B29C 45/14; B32B 15/08; B32B 15/18

(52) U.S. Cl. CPC F16H 53/025; B32B 15/08; B32B 15/18; B29C 45/14622; B29C 45/0005; B32B 2262/106; B29K 2105/14

(57) ABSTRACT

A structural member of a vehicle includes a metal body, a first resin layer and a second resin layer. The metal body is made of metal. The first resin layer is provided on the metal body in a layering direction and includes a first thermoplastic resin. The second resin layer is provided on the first resin layer in the layering direction and includes a second thermoplastic resin and carbon fiber.

### CROSS-REFERENCE TO RELATED APPLICATIONS

The present application claims priority under 35 U. S. C. §119 to Japanese Patent Application No. 2016-036547, filed Feb. 29, 2016. The contents of this application are incorporated herein by reference in their entirety.

### BACKGROUND OF THE INVENTION

Field of the Invention

The present invention relates to a structural member of a vehicle, and a method of manufacturing the same.

Discussion of the Background

In general, a camshaft of a vehicle engine formed of a forged part made of special steel containing nickel and chromium, for example, or a casting made of special cast iron have been known (see Japanese Patent Application Publication No. 2010-149135 and Japanese Patent Application Publication No. 2008-274908, for example). There is a need for such a structural member of vehicle to become lighter, to meet recent requirements of vehicle weight reduction for saving energy and achieving high fuel economy.

### SUMMARY OF THE INVENTION

According to one aspect of the present invention, a structural member of a vehicle includes a metal base material and a resin layer containing thermoplastic resin and formed on the base material. The resin layer has a first resin layer and a second resin layer in this order from the base material side, and at least the second resin layer contains carbon fiber.

According to another aspect of the present invention, a structural member of a vehicle includes a metal base material and a resin layer containing thermoplastic resin and formed on the base material. The resin layer contains carbon fiber oriented in one direction.

According to further aspect of the present invention, a structural member of a vehicle includes a metal body, a first resin layer and a second resin layer. The metal body is made of metal. The first resin layer is provided on the metal body in a layering direction and includes a first thermoplastic resin. The second resin layer is provided on the first resin layer in the layering direction and includes a second thermoplastic resin and carbon fiber.

According to further aspect of the present invention, a structural member of a vehicle includes a metal body and a resin layer. The metal body is made of metal. The resin layer is provided on the metal body and includes a thermoplastic resin and carbon fiber oriented in one direction.

According to further aspect of the present invention, a method of manufacturing the structural member of a vehicle includes providing a first resin layer including a first thermoplastic resin on a metal body made of metal in a layering direction. A second resin layer including carbon fiber and a second thermoplastic resin is provided on the base body via the first resin layer in the layering direction. The first thermoplastic resin is heated to a temperature higher than a glass-transition temperature of the first thermoplastic resin to bond the second resin layer to the metal body.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a perspective view of a camshaft as a structural member of a vehicle of an embodiment of the present invention.

FIG. 2A is a cross-sectional view taken along IIa-IIa of FIG. 1, and FIG. 2B is a partially enlarged view of area IIb in FIG. 2A.

FIGS. 3A to 3E are explanatory drawings of steps of a manufacturing method of the camshaft (structural member of a vehicle) of FIG. 1.

FIGS. 4A to 4C are explanatory drawings of the configuration of a structural member of a vehicle according to another embodiment of the present invention.

FIGS. 5A and 5B are explanatory drawings of the configuration of a structural member of a vehicle according to another embodiment of the present invention.

FIGS. 6A to 6C are graphs showing evaluation results of a structural member of a vehicle according to an embodiment of the present invention, where FIG. 6A is a graph showing the experiment result of flexural rigidity [N·m²], FIG. 6B is a graph showing the experiment result of torsional rigidity [N·m²], and FIG. 6C is a graph showing the measurement result of mass [g].

### DESCRIPTION OF THE EMBODIMENTS

The embodiments will now be described with reference to the accompanying drawings, wherein like reference numerals designate corresponding or identical elements throughout the various drawings.

Next, a description will be given of a structural member of a vehicle according to embodiments of the present invention. In the embodiments of the present invention, the vehicle refers to a movable structure such as a running vehicle, and a traveling ship and aircraft.

Of intake and exhaust camshafts attached to an engine main body of an inline four-cylinder four-cycle engine, the intake camshaft is used as an example of the structural member of the vehicle according to the embodiment. Note that the structural member of the vehicle according to an embodiment of the present invention is not limited to such a camshaft, and is applicable to various other members, as will be mentioned later.

As will be described later in detail, a main characteristic of the camshaft (the structural member of the vehicle) according to the embodiment is that the configuration includes a composite structure of metal, thermoplastic resin, and carbon fiber. Hereinafter, a description will be given of a camshaft, and then of a manufacturing method of the camshaft.

### Camshaft

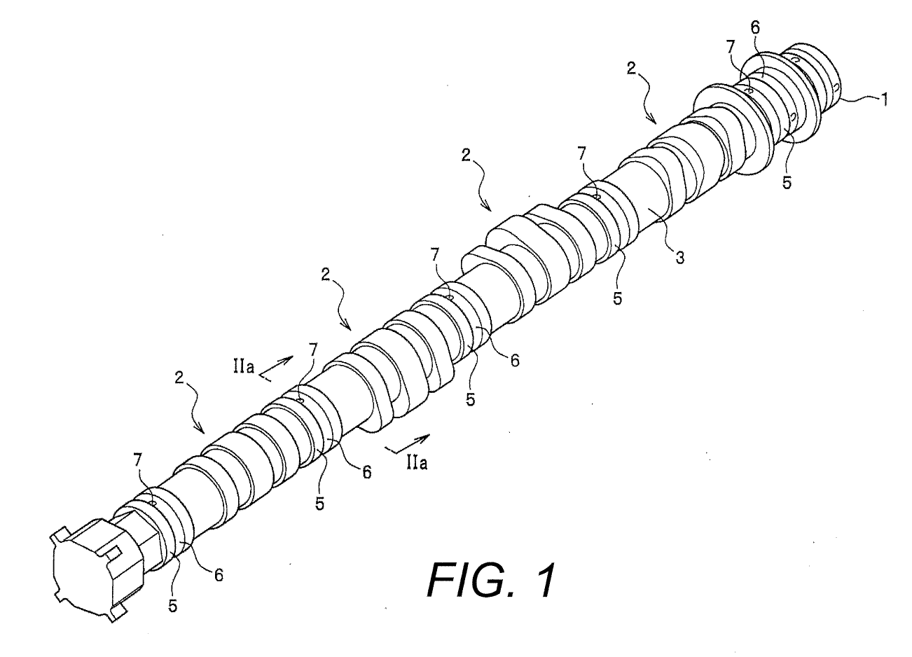

FIG. 1 is a perspective view of a camshaft 1 of an embodiment of the present invention.

As shown in FIG. 1, the camshaft 1 is formed into a substantially bar-like body, and includes a shaft portion 3 having a substantially columnar outer shape, and multiple cam portions 2 provided along the longitudinal direction of the camshaft 1.

The cam portion 2 is formed of a thick plate having an egg-shaped outline in a plan view, when viewed in the direction of the rotation axis of the camshaft 1. Rotation of the camshaft 1 around the rotation axis causes the cam portion 2 to open and close a valve on the engine main body side, through an unillustrated rocker arm. The cam portions 2 are arranged at predetermined intervals along the extending direction of the rotation axis of the camshaft 1, in positions corresponding to the valves (not shown). Note that the camshaft 1 is applicable to any of the OHV, SOHO, and DOHC forms.

Journal portions 5 are formed in parts of the shaft portion 3. The journal portion 5 has a peripheral surface concentric with the rotation axis of the camshaft 1. The journal portions 5 are supported by unillustrated multiple bearings provided on the engine main body side, and allow the camshaft 1 to be rotatably supported to the engine main body side.

Multiple journal portions 5 are provided at predetermined intervals along the direction of the rotation axis of the camshaft 1, in positions corresponding to the bearings (not shown).

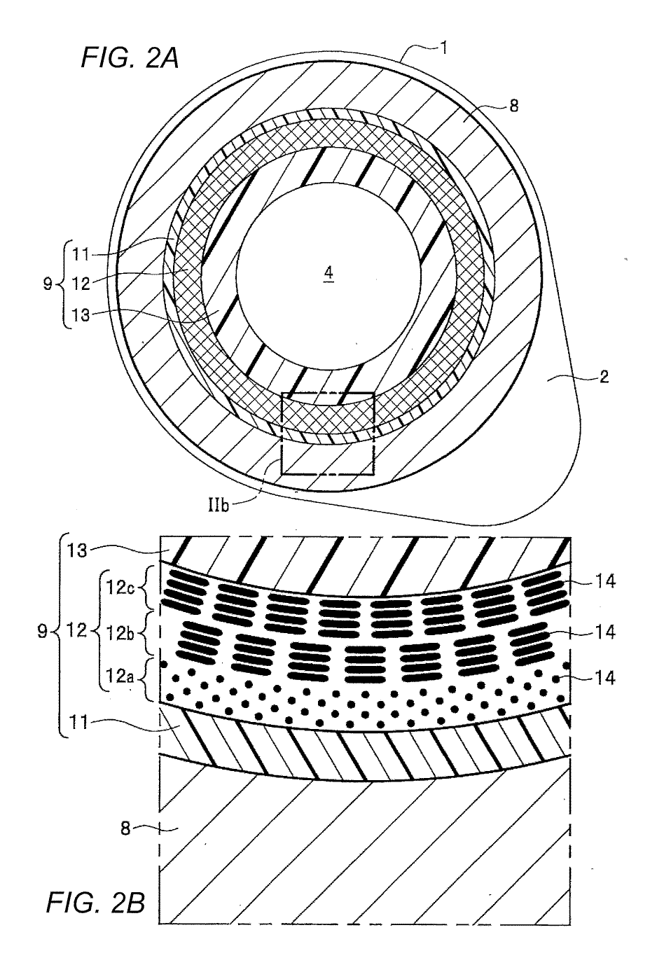

In FIG. 1, reference numeral 6 indicates an annular groove portion that forms an oil passage of engine oil with the aforementioned bearing (not shown), and reference numeral 7 indicates a later-mentioned connection hole that connects a later-mentioned hollow portion 4 (see FIG. 2A) and the groove portion 6 of the camshaft 1. Incidentally, engine oil of an oil pan (not shown) is supplied to the hollow portion 4 of the camshaft 1, through a predetermined path.

This camshaft 1 may be formed by: attaching multiple cam portions 2 to a single cylindrical shaft portion 3; connecting together sub-assemblies, each formed of a piece of a cylindrical shaft portion 3 divided into multiple pieces and the cam portion 2 formed integrally with each piece of the divided shaft portion 3; or previously forming the cylindrical shaft portion 3 and the cam portion 2 as one body, by shaving a forged part or by casting, for example.

FIG. 2A is a cross-sectional view taken along IIa-IIa of FIG. 1, and FIG. 2B is a partially enlarged view of area IIb in FIG. 2A.

As shown in FIG. 2A, the camshaft 1 of the embodiment has the aforementioned hollow portion 4 that is circular in cross-sectional view. The hollow portion 4 extends in the longitudinal direction of the camshaft 1.

The configuration of this camshaft 1 includes a metal base material 8 (a metal body 8) and a resin layer 9.

The base material 8 forms the outer shape of the camshaft 1, and except for the cam portion 2 protruding radially outward from the peripheral surface of the shaft portion 3, the camshaft 1 has a substantially cylindrical shape.

An inner surface (inner wall) that forms the hollow portion 4 of the base material 8 of the embodiment is subjected to a surface roughening treatment. Examples of the surface roughening treatment include known methods of physically or chemically etching the surface of the base material 8. Physical etching methods include laser treatment, blasting treatment, and machining treatment by use of tools, for example. Also, treatments using chemical etching include AMALPHA (registered trademark of MEC Co., Ltd.) treatment, for example.

The metal of the base material 8 is not particularly limited, and examples include known camshaft materials such as special steel containing nickel and chromium, and special cast iron.

The resin layer 9 of the embodiment is formed on the inner surface (inner wall) side of the substantially cylindrical (tubular) base material 8.

The configuration of this resin layer 9 includes a first resin layer 11, a second resin layer 12, and a third resin layer 13. The individual layers of the first resin layer 11, the second resin layer 12, and the third resin layer 13 are formed into a cylindrical shape concentric with the rotation axis of the camshaft 1.

As shown in FIG. 2B, the first resin layer 11, the second resin layer 12, and the third resin layer 13 are laid on top of one another in this order from the base material 8 side, in the resin layer 9. Note that for the sake of simplicity of the drawing, the sectional shape and size of a carbon fiber 14 shown in FIG. 2B do not reflect the actual sectional shape and size of a carbon fiber.

The configuration of the first resin layer 11 contains a thermoplastic resin.

Although not limited, examples of the thermoplastic resin include: polypropylene (PP), polyamide (PA), thermoplastic polyurethane (TPU), polycarbonate (PC), polymethyl methacrylate (PMMA), polyether ether ketone (PEEK), polyphenylene sulfide (PPS), and polyether-imide (PEI).

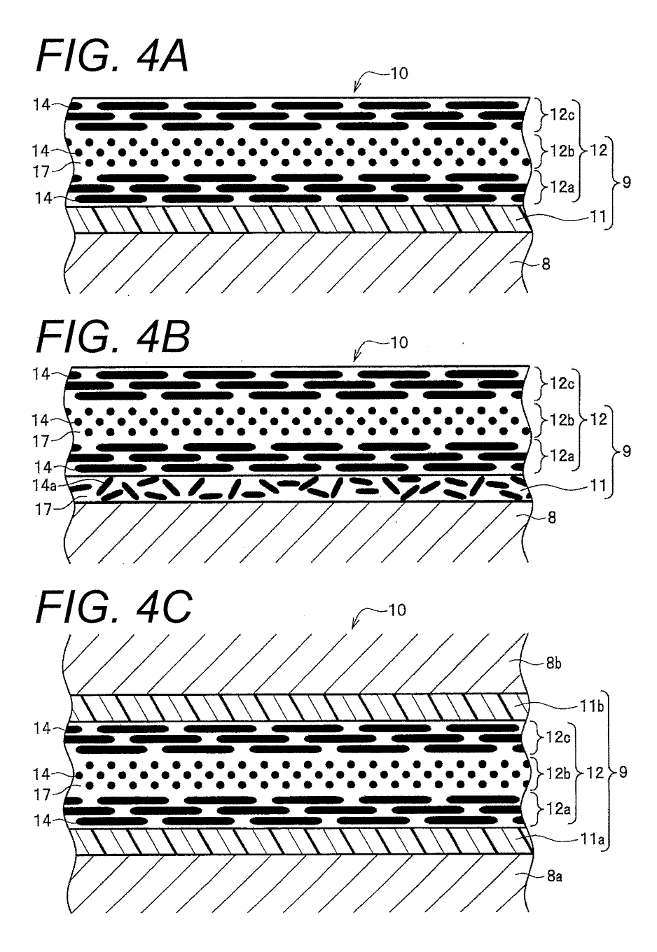

Although the first resin layer 11 of the embodiment is assumed to contain only thermoplastic resin, a non-oriented short carbon fiber 14a (see FIG. 4B) may be contained in the first resin layer 11, as will be mentioned later.

The configuration of the second resin layer 12 contains the carbon fiber 14 in a thermoplastic resin as a matrix.

Examples of the thermoplastic resin of the second resin layer 12 are the same as the aforementioned thermoplastic resin of the first resin layer 11. It is desirable that the thermoplastic resin of the first resin layer 11 and the thermoplastic resin of the second resin layer 12 are the same kind. In other words, when polyamide is selected as the thermoplastic resin of the first resin layer 11, for example, it is desirable that polyamide is selected as the thermoplastic resin of the second resin layer 12.

The carbon fiber 14 contained in the second resin layer 12 is desirably oriented in one direction.

As shown in FIG. 2B, the second resin layer 12 of the embodiment is configured of a first layer 12a, a second layer 12b, and a third layer 12c having the carbon fiber 14 oriented in different directions, in this order from the first resin layer 11 side.

As will be described later in detail, the carbon fiber 14 in the first layer 12a is oriented at 0 degrees (parallel) with respect to the rotation axis of the camshaft 1. As will be described later in detail, the carbon fiber 14 in the second layer 12b is oriented to form a spiral at 45 degrees with respect to the rotation axis of the camshaft 1. As will be described later in detail, the carbon fiber 14 in the third layer 12c is oriented to form a spiral at −45 degrees with respect to the rotation axis of the camshaft 1.

The carbon fiber 14 oriented in one direction in the second resin layer 12 includes not only the carbon fiber having a laminated structure where the orientation angle of the carbon fiber 14 varies in the lamination direction as mentioned above, but also a UD material, for example, in which the carbon fiber 14 is oriented in only one direction, and textile into which the carbon fiber 14 is woven at a certain angle.

Such a carbon fiber 14 oriented in one direction may be any of a PAN type and a pitch type.

A ratio (T1/T2) of a thickness T1 of the first resin layer 11 to a thickness T2 of the second resin layer 12 in the resin layer 9 is desirably 0.001 to 0.1.

By setting the resin layer 9 according to this ratio, a certain strength based on the carbon fiber 14 is applied to the camshaft 1, and the bonding strength of the second resin layer 12 to the base material 8 can be made extremely stronger than when the first resin layer 11 is not provided.

The configuration of the third resin layer 13 includes a thermoplastic resin. Examples of the thermoplastic resin of the third resin layer 13 are the same as the aforementioned thermoplastic resin of the first resin layer 11.

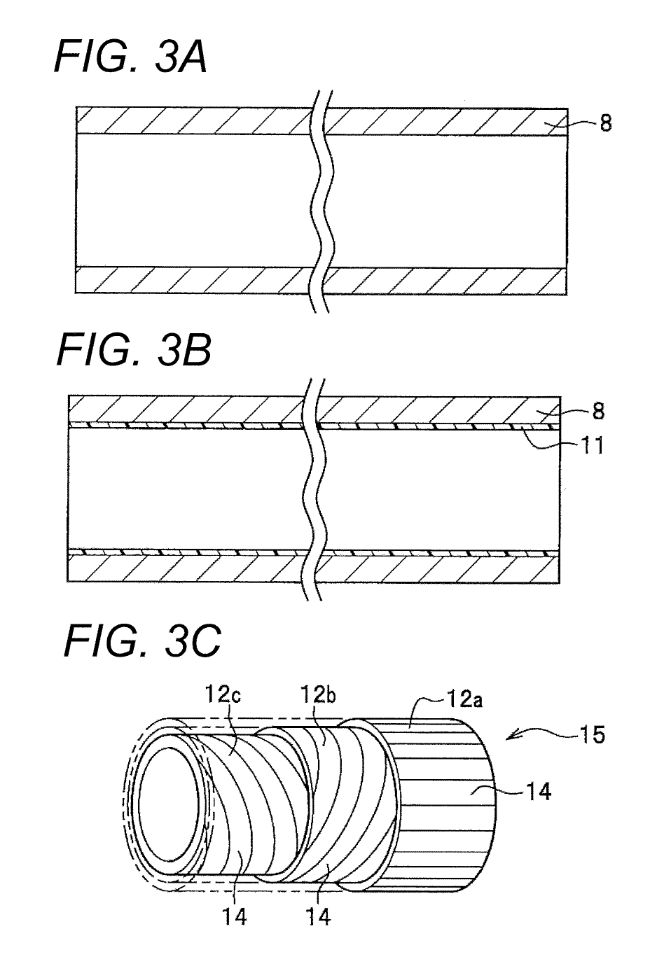

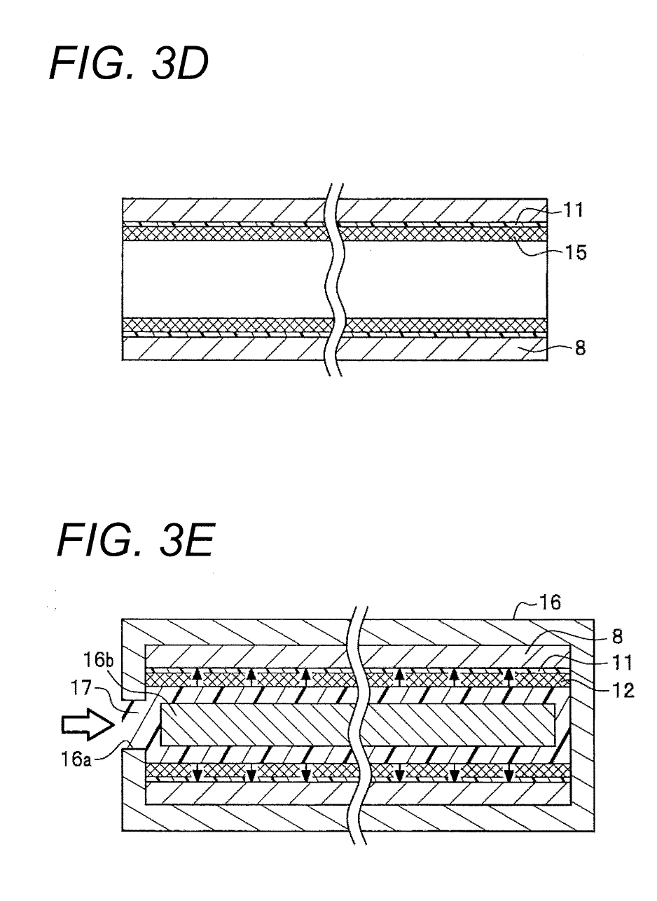

As will be described later in detail, the third resin layer 13 is a hardened state of a fused thermoplastic resin 17 (see FIG. 3E) that presses the second resin layer 12 to the base material 8 side.

Note that the third resin layer 13 may be omitted, as will be mentioned later.

### Manufacturing Method of Camshaft

Next, a description will be given of a manufacturing method of the camshaft 1 (the structural member of the vehicle) shown in FIG. 1.

FIGS. 3A to 3E are explanatory drawings of steps of the manufacturing method of the camshaft 1.

In the embodiment, a description will be given of a manufacturing method of the aforementioned camshaft 1 (see FIG. 1) in which the multiple cam portions 2 (see FIG. 1) are later attached to the single cylindrical shaft portion 3 (see FIG. 1), as an example.

As shown in FIGS. 3A to 3E, the manufacturing method of the camshaft 1 includes: a first resin layer placement step (first step) of placing the aforementioned first resin layer 11 on the base material 8; a second resin layer placement step (second step) of placing the aforementioned second resin layer 12 on the base material 8 with the first resin layer 11 interposed therebetween; and a bonding step (third step) of bonding the second resin layer 12 onto the base material 8, by heating the thermoplastic resin contained at least in the first resin layer 11 to a higher temperature than a glass-transition temperature.

A more specific description will be given of this manufacturing method. As shown in FIG. 3A, first, a substantially cylindrical body is prepared as the metal base material 8 constituting the shaft portion 3 (see FIG. 1). The length of the base material 8 is substantially equivalent to the length of the camshaft 1 (see FIG. 1).

Next, as shown in FIG. 3B, the first resin layer 11 is placed on the inner surface (inner wall) of the base material 8.

Examples of the method of placing the first resin layer 11 on the inner surface of the base material 8 include: placing a resin sheet or powdered resin, for example, made of the thermoplastic resin of the first resin layer 11 on the inner surface of the base material 8; placing a previously created cylindrical body made of the thermoplastic resin of the first resin layer 11 inside the base material 8; and applying a fused thermoplastic resin of the first resin layer 11 on the inner surface of the base material 8. Note that as will be mentioned later, if the base material 8 is formed into a plate shape, the first resin layer 11 may be formed by fusing a pellet-shaped thermoplastic resin placed on top of the base material 8.

As shown in FIG. 3C, in the manufacturing method of the embodiment, a cylindrical body 15 for forming the second resin layer 12 (see FIG. 2A) is prepared separately from the base material 8 (see FIG. 3A). The cylindrical body 15 has the same layer configuration as the second resin layer 12, and has the first layer 12a, the second layer 12b, and the third layer 12c. That is, the first layer 12a, the second layer 12b, and the third layer 12c contain the carbon fiber 14 oriented in certain directions, in the thermoplastic resin as a matrix. Specifically, the carbon fiber 14 in the first layer 12a is oriented at 0 degrees (parallel) with respect to the center axis of the cylindrical body 15. The carbon fiber 14 in the second layer 12b is oriented to form a spiral aligned at 45 degrees with respect to the rotation axis of the cylindrical body 15. The carbon fiber 14 in the third layer 12c is oriented to form a spiral aligned at −45 degrees with respect to the center axis of the cylindrical body 15.

Note that as the first layer 12a, the second layer 12b, and the third layer 12c in the second resin layer 12 of the embodiment, a UD material in which the carbon fiber 14 is oriented in one direction in a thermoplastic resin as a matrix may be layered on the peripheral surface of the columnar shape, for example. A commercially available UD material may be used.

Next, as shown in FIG. 3D, in this manufacturing method, the cylindrical body 15 is placed inside the first resin layer 11 to place the second resin layer 12 on the inner surface (inner wall) of the base material 8, with the first resin layer 11 interposed therebetween.

Also, as a modification of this manufacturing method, an assembly (not shown) in which a cylindrical body (not shown) corresponding to the first resin layer 11 (see FIG. 3B) is placed on the outer side of the cylindrical body 15 shown in FIG. 3C may be prepared separately from the base material 8 (see FIG. 3A), and the assembly may be placed inside the base material 8.

According to this modification, by placing the aforementioned assembly inside the base material 8, the aforementioned first step and the aforementioned second step can be performed at once, and the manufacturing process can be simplified.

Next, as mentioned above, in this manufacturing method, the thermoplastic resin contained in at least the first resin layer 11 (see FIG. 3D) is heated at a higher temperature than the glass-transition temperature. This plasticizes or fuses the first resin layer 11, so that the boundary surface with the base material 8 adheres and disappears. Also, the first resin layer 11 plasticizes or fuses, so that the boundary surface with the second resin layer 12 (see FIG. 3D) adheres and disappears.

The heating method is not particularly limited, and examples include joule heat, infrared rays, and use of a heating medium (e.g., heating fluid), for example. Note that the first resin layer 11 may be heated from the base material 8 side, from the second resin layer 12 side, or from both of the base material 8 side and the second resin layer 12 side.

Then, as the thermoplastic resin of the first resin layer 11 cools to a temperature below the glass-transition temperature and the thermoplastic resin hardens, the second resin layer 12 is bonded to the base material 8 with the first resin layer 11 interposed therebetween (third step). Thereafter, predetermined oil passages such as the aforementioned connection hole 7 (see FIG. 1) are formed in predetermined positions in the shaft portion 3 (see FIG. 1), and the cam portions 2 (see FIG. 1) are attached to complete the series of manufacturing steps of the camshaft 1 (the structural member of the vehicle).

In the aforementioned bonding step (third step) in the manufacturing method of the camshaft 1 (the structural member of the vehicle) described above, the thermoplastic resin of at least the first resin layer 11 is heated to a higher temperature than the glass-transition temperature. However, it is desirable that the thermoplastic resin of the second resin layer 12 also be heated to a higher temperature than the glass-transition temperature. Additionally, in the aforementioned bonding step (third step), a pressing step of pressing the second resin layer 12 to the base material 8 side is desirably performed in parallel with the step of heating the first resin layer 11 and the second resin layer 12.

The modification of the bonding step (third step) described above is performed by applying a heating fluid having a predetermined pressure on the second resin layer 12, while supporting the base material 8. To be specific, this modification is performed by use of a certain mold 16, for example, as shown in FIG. 3E.

More specifically, the bonding step (third step) may include: an in-mold placement step (fourth step) of placing the aforementioned base material 8 in which the aforementioned first resin layer 11 and the aforementioned second resin layer 12 are arranged as mentioned earlier, in a certain mold 16; a heated resin-injection step (fifth step) of injecting the thermoplastic resin 17 heated to a higher temperature than the glass-transition temperature into the mold 16; and a pressing and heating step (sixth step) of pressing the aforementioned second resin layer 12 to the aforementioned base material 8 side with the aforementioned first resin layer 11 interposed therebetween, by pressure of the injected aforementioned thermoplastic resin 17, and also heating the thermoplastic resin of the aforementioned first resin layer 11 and the aforementioned second resin layer 12 to a higher temperature than the glass-transition temperature, by the injected aforementioned thermoplastic resin 17.

The mold 16 used in the bonding step (third step) described above includes a cavity formed into the outer shape of the base material 8, an injection port 16a of the aforementioned heated thermoplastic resin 17, and a core 16b arranged in a position corresponding to the hollow portion 4 (see FIG. 2A) formed inside the shaft portion 3 (see FIG. 2A).

In the bonding step (third step), the base material 8 in which the first resin layer 11 and the second resin layer 12 are arranged is set inside the mold 16, and the aforementioned thermoplastic resin 17, which is injected with a predetermined pressure from an injection molding machine, for example, is injected into the mold 16 through the injection port 16a. Then, the thermoplastic resin 17 injected into the mold 16 fills a gap between the second resin layer 12 and the core 16b with a predetermined pressure.

The thermoplastic resin 17 inside the mold 16 heats the thermoplastic resin of the first resin layer 11 and the second resin layer 12 at a higher temperature than the glass-transition temperature.

The thermoplastic resin 17 inside the mold 16 presses the second resin layer 12 to the base material 8 side as mentioned earlier, with a pressure depending on the pressure with which the injection molding machine injects the thermoplastic resin 17. This connects the second resin layer 12 more firmly to the base material 8 with the first resin layer 11 interposed therebetween.

A thermoplastic resin having a higher glass-transition temperature than the thermoplastic resin of the first resin layer 11 and the second resin layer 12, is desirably used as the thermoplastic resin 17.

When the thermoplastic resin 17 injected into the mold 16 cools to a temperature below the glass-transition temperature and hardens, the mold is removed, so that the hollow portion 4 (see FIG. 1) is formed in an area from which the core 16b is removed.

The hardened thermoplastic resin 17 forms the third resin layer 13 (see FIG. 1), and holds the second resin layer 12 from inside.

Also, when such a modification of the bonding step (third step) is not applied to the aforementioned manufacturing method of the camshaft 1 (the structural member of the vehicle), the camshaft 1 omitting the third resin layer 13 can be obtained.

Although the heating fluid having a predetermined pressure is assumed to be thermoplastic resin injected from the injection molding machine in the modification of the bonding step (third step) described above, the heating fluid is not limited to this. Oil (mineral oil, silicone oil) compressed by a higher pressure than atmospheric pressure, for example, may be used as another heating fluid of the modification. The heating fluid may be applied on the second resin layer 12, with another layer on the second resin layer 12 interposed therebetween. Incidentally, “another layer” may be any of what is left on the camshaft 1 as a result, or what is removed in a later step and does not remain on the resultant camshaft 1.

Next, effects of the camshaft 1 (the structural member of the vehicle) according to the embodiment and its manufacturing method will be described.

According to the camshaft 1 (such as the structural member of the vehicle) described in the embodiment, since the second resin layer 12 containing carbon fiber is bonded to the metal base material 8, the camshaft can be made stronger than that formed only of the base material 8. In other words, when comparing the metal amount between the camshaft 1 (the structural member of the vehicle) according to the embodiment, and a camshaft having the same strength and formed only of the metal constituting the base material 8, the camshaft 1 of the embodiment uses less metal. Hence, the camshaft 1 of the embodiment has certain strength, and is lighter than a conventional metal camshaft (see Patent Documents 1, 2, for example).

Also, in the camshaft 1 (the structural member of the vehicle) according to the embodiment, the second resin layer 12 containing the carbon fiber 14 is bonded to the metal base material 8, with the first resin layer 11 containing thermoplastic resin interposed therebetween. Hence, in the camshaft 1 (the structural member of the vehicle) according to the embodiment, the bonding strength of the second resin layer 12 to the base material 8 is made even stronger than when the second resin layer 12 is bonded directly to the base material 8.

Also, in the camshaft 1 (the structural member of the vehicle) according to the embodiment, the resin layer 9 is formed on the inner wall of the base material 8 formed of a metal tubular body. That is, the outer layer of the resin layer 9 is covered with metal in this configuration. Hence, the camshaft 1 (the structural member of the vehicle) has more strength to withstand impulsive force applied from outside, as compared to providing the resin layer 9 on an outer wall of the base material 8.

Also, according to the manufacturing method of the camshaft 1 (the structural member of the vehicle) according to the embodiment, since the second resin layer 12 is bonded to the base material 8 with the first resin layer 11 interposed therebetween, the bonding strength of the second resin layer 12 to the base material 8 can be improved.

Also, in the manufacturing method of the embodiment, at least the first resin layer 11 is heated at a higher temperature than the glass-transition temperature. Hence, the thermoplastic resin constituting the first resin layer 11 adheres to the base material 8 and the second resin layer 12. This makes the bonding strength of the second resin layer 12 to the base material 8 even stronger. And by also heating the second resin layer 12 at a higher temperature than the glass-transition temperature at this time, the bonding strength of the second resin layer 12 to the base material 8 is made yet even stronger.

Also, in the manufacturing method of the embodiment, the second resin layer 12 is pressed to the base material 8 side, while heating at least the first resin layer 11 at a higher temperature than the glass-transition temperature. Hence, the bonding strength of the second resin layer 12 to the base material 8 is surely made stronger.

Also, in the aforementioned modification (see FIG. 3E) of the manufacturing method of the embodiment, the second resin layer 12 is bonded to the base material 8 inside the mold 16. According to this modification, the base material 8 to which the second resin layer 12 is bonded can be held more stably.

Also, in the modification of the manufacturing method of the embodiment shown in FIG. 3E, the fused thermoplastic resin 17 is introduced into the mold 16, and the thermoplastic resin 17 heats the first resin layer 11 and the second resin layer 12 to a higher temperature than the glass-transition temperature. According to this modification, the first resin layer 11 and the second resin layer 12 can be heated evenly at a constant temperature. This homogenizes the bonding strength of the second resin layer 12 to the inner wall surface of the base material 8, over the entire peripheral surface.

Also, in the modification, the pressure with which the fused thermoplastic resin 17 is introduced into the mold 16 presses the second resin layer 12 to the base material 8 side. According to this modification, the second resin layer 12 is evenly pressed to the base material 8 side, in the direction of the plane of the inner wall surface of the base material 8. Hence, the bonding strength of the second resin layer 12 to the inner wall surface of the base material 8 is homogenized over the entire peripheral surface.

Note that in the modification, the mold 16 may be heated with a certain heater, to heat at least the first resin layer 11 to a higher temperature than the glass-transition temperature.

Although the embodiment of the present invention has been described above, the present invention is not limited to the embodiment, and can be implemented in various modes. Note that in the following other embodiments, components similar to the aforementioned embodiment are assigned the same reference numerals, and detailed descriptions thereof will be omitted.

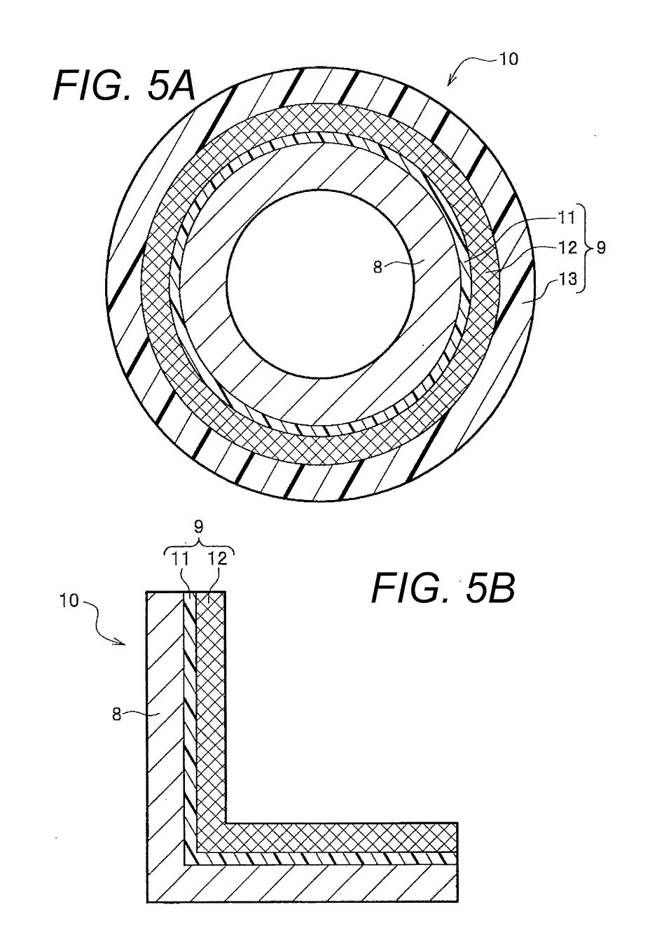

FIGS. 4A to 4C and FIGS. 5A and 5B are explanatory drawings of the configuration of a structural member of a vehicle 10 of other embodiments of the present invention. Note that for the sake of simplicity of the drawing, the shape and size of a carbon fiber 14 shown in FIGS. 4A to 4C do not reflect the actual diameter and sectional shape of a carbon fiber.

Although the aforementioned embodiment described the camshaft 1 (the structural member of the vehicle) in which the resin layer 9 is formed on the inner wall surface of the base material 8 formed of a tubular body (see FIGS. 2A and 2B), the structural member of the vehicle according to the embodiment of the present invention is not limited to this. The structural member of the vehicle according to the embodiment of the present invention may also be used as a part such as a power train (power transmission device), a housing of an onboard device, a suspension member, and a body frame, for example. Moreover, the structural member of the vehicle according to the embodiment of the present invention is not limited to a bar-like member such as the aforementioned camshaft 1, and may be formed into various shapes depending on the applied member. Also, the kind and shape, for example, of the metal of the base material 8 may be selected according to the part to which the structural member of the vehicle is applied.

As shown in FIG. 4A, a structural member of a vehicle 10 has a resin layer 9 on a certain plane of a base material 8. The metal of the base material 8 is not particularly limited, and metals normally used for the member to which the structural member of the vehicle 10 is applied may be used. A surface of the base material 8 on the side of the resin layer 9 is desirably subjected to a surface roughening treatment.

In FIG. 4A, reference numeral 11 indicates a first resin layer, and reference numeral 12 indicates a second resin layer. Although not limited, examples of the thermoplastic resin contained in the first resin layer 11 and the second resin layer 12 include: polypropylene (PP), polyamide (PA), thermoplastic polyurethane (TPU), polycarbonate (PC), polymethyl methacrylate (PMMA), polyether ether ketone (PEEK), polyphenylene sulfide (PPS), and polyether-imide (PEI).

The first resin layer 11 of this structural member of the vehicle 10 may be formed in the same manner as in the camshaft 1 (the structural member of the vehicle) according to the aforementioned embodiment.

The second resin layer 12 of this structural member of the vehicle 10 is assumed to have a first layer 12a in which a carbon fiber 14 is oriented at 0 degrees, a second layer 12b in which the carbon fiber 14 is oriented at 90 degrees, and a third layer 12c in which the carbon fiber 14 is oriented at 0 degrees, which are laid on top of one another in this order from the base material 8 side, in a thermoplastic resin 17 as a matrix. Note that the carbon fiber 14 of the second resin layer 12 includes not only the carbon fiber having a laminated structure where the orientation angle of the carbon fiber 14 varies in the lamination direction as mentioned earlier, but also a UD material, for example, in which the carbon fiber is oriented in only one direction, and textile into which the carbon fiber 14 is woven at a certain angle.

Note that unlike the camshaft 1 (structural member of vehicle) of the aforementioned embodiment, the third resin layer 13 (see FIG. 2A) is omitted from this structural member of the vehicle 10. However, the third resin layer 13 may instead be formed on the second resin layer 12.

When applied to a member that requires bearing strength, this structural member of the vehicle 10 exerts a certain bearing strength, and also is lighter than a member made only of metal.

As shown in FIG. 4B, a structural member of the vehicle 10 has a first resin layer 11 containing a non-oriented short carbon fiber 14a, in a thermoplastic resin 17 as a matrix, as mentioned earlier. “Non-oriented” means that the contained short carbon fiber 14a is oriented randomly in the direction of the fiber axis. The length of the short carbon fiber 14a is desirably 0.02 to several millimeters. A chopped carbon fiber may be used as the short carbon fiber 14a, for example.

The short carbon fiber 14a may be any of a PAN type and a pitch type.

Note that in FIG. 4B, reference numeral 8 indicates a base material, reference numeral 11 indicates a first resin layer constituting a resin layer 9, reference numeral 12 indicates a second resin layer constituting the resin layer 9, and reference numeral 14 indicates a carbon fiber contained in the second resin layer 12 and oriented in certain directions in a first layer 12a, a second layer 12b, and a third layer 12c.

The base material 8 and the second resin layer 12 of this structural member of the vehicle 10 may be configured in the same manner as the base material 8 and the second resin layer 12 of the structural member of the vehicle 10 shown in FIG. 4A, respectively.

Also, unlike the camshaft 1 (the structural member of the vehicle) according to the aforementioned embodiment, the third resin layer 13 (see FIG. 2A) is omitted from this structural member of the vehicle 10. However, the third resin layer 13 may instead be formed on the second resin layer 12.

Since this structural member of the vehicle 10 has the first resin layer 11 containing the short carbon fiber 14a, the bonding strength of the second resin layer 12 to the base material 8 can be made stronger, and the shear strength between the base material 8 and the second resin layer 12 can be made stronger. Also, according to this structural member of the vehicle 10, rigidity of the structural member of the vehicle 10 can be improved even more.

Also, since the first resin layer 11 of this structural member of the vehicle 10 has a matrix configured of thermoplastic resin, it can be formed easily by extrusion molding, for example.

As shown in FIG. 4C, a structural member of a vehicle 10 is configured of a base material 8a, a first resin layer 11a, a second resin layer 12, a first resin layer 11b, and a base material 8b laid on top of one another and bonded in this order. Components similar to the base material 8, first resin layer 11, and second resin layer 12 of the structural member of the vehicle 10 shown in FIG. 4A are applicable to the base materials 8a, 8b, first resin layers 11a, 11b, and second resin layer 12 of this structural member of the vehicle 10, respectively. Note that in FIG. 4C, reference numeral 14 indicates a carbon fiber contained in the second resin layer 12 and oriented in certain directions in a first layer 12a, a second layer 12b, and a third layer 12c, and reference numeral 17 indicates a thermoplastic resin contained in a resin layer 9.

According to this structural member of the vehicle 10, bearing strength can be made even stronger than the structural member of the vehicle 10 shown in FIG. 4A.

Also, the configuration shown in FIG. 4A that has the second resin layer 12 containing the carbon fiber 14 oriented in one direction on the base material 8, may omit the first resin layer 11. In other words, this structural member of the vehicle (not shown) of the modification omitting the first resin layer 11 includes a metal base material, and a resin layer containing thermoplastic resin and formed on the base material, while the configuration of the resin layer contains a carbon fiber oriented in one direction.

As shown in FIG. 5A, the configuration of a structural member of the vehicle 10 has a first resin layer 11, a second resin layer 12, and a third resin layer 13 as a resin layer 9 in this order, on an outer wall of a base material 8 formed of a metal tubular body.

The metal of the base material 8 is not particularly limited, and metals normally used for the member to which the structural member of the vehicle 10 is applied may be used. A surface of the base material 8 on the side of the resin layer 9 is desirably subjected to a surface roughening treatment.

Components similar to the first resin layer 11, second resin layer 12, and third resin layer 13 of the camshaft 1 (the structural member of the vehicle) shown in FIG. 2A are applicable to the first resin layer 11, second resin layer 12, and third resin layer 13 of this structural member of the vehicle 10, respectively.

According to this structural member of the vehicle 10, since the resin layer 9 is formed on the outer wall surface of the base material 8, there is more freedom in design such as the thickness of the resin layer 9, and the manufacturing process can be made easier.

Also, since this structural member of the vehicle 10 does not have the resin layer 9 on the hollow portion 4 side, the structural member can be used as piping for feeding a liquid that chemically affects thermoplastic resin.

As shown in FIG. 5B, a structural member of the vehicle 10 is a bar-like member formed into a substantial L shape in cross-sectional view, and is assumed to extend linearly, or curve in the longitudinal direction. This structural member of the vehicle 10 is assumed to be assembled and used as a frame member, or be used as a reinforcement member for reinforcing a pillar, bumper, or various brackets, for example. The base material 8 may be formed into substantially the same shape as the structural member of the vehicle 10. Material of the base material 8 is not particularly limited, as long as it is a metal.

The configuration of this structural member of the vehicle 10 has a first resin layer 11 and a second resin layer 12 laid on top of one another in this order, on a surface of the base material 8 on the inside corner side. Reference numeral 9 indicates a resin layer configured of the first resin layer 11 and the second resin layer 12.

Components similar to the first resin layer 11 and second resin layer 12 of the structural member of the vehicle 10 shown in FIG. 4A are applicable to the first resin layer 11 and second resin layer 12 of this structural member of the vehicle 10, respectively.

In addition to the aforementioned effects, this structural member of the vehicle 10 has a broader utility as an assembly part. Note that modifications of this structural member of the vehicle 10 include those having a U-shaped or H-shaped cross section, and those having a circular, oval, or polygonal closed cross section, for example. Also, instead of providing the first resin layer 11 and the second resin layer 12 on only one surface of the base material 8, the layers may be provided on both surfaces that sandwich the base material 8.

Also, although the carbon fiber 14 contained in the second resin layer 12 is assumed to be oriented in one direction in embodiments (including aforementioned other embodiments) of the present invention, a random mat made of carbon fiber by a papermaking method, or a carbon fiber woven in a net shape and containing thermoplastic resin may instead be used as the second resin layer 12.

Also, the structural member of the vehicle according to the embodiment of the present invention is not limited to the use in vehicles, and is also applicable to structural members used in ships and aircrafts.

### EXAMPLE

Hereinafter, a description will be given of an example in which the effects of the structural member of the vehicle according to the embodiment of the present invention were verified.

In the example, a cylindrical shaft having a 400 mm length was created as the structural member of the vehicle. The inner diameter of the shaft was 10 mm.

To create the shaft, first, a steel pipe (as base material 8 in FIG. 2A) having a 400 mm length, a 25 mm outer diameter, and a 21 mm inner diameter was prepared.

The shaft was obtained by forming a resin layer 9 configured of a first resin layer 11, a second resin layer 12, and a third resin layer 13 shown in FIG. 2A, on an inner wall surface of the steel pipe. The first resin layer 11, the second resin layer 12, and the third resin layer 13 were formed on the inner wall surface of the steel pipe, according to the modification of FIG. 3E, in which a fused thermoplastic resin is injected into a mold 16.

Note that polyether ether ketone (PEEK) was used as the thermoplastic resin of the first resin layer 11 and the thermoplastic resin of the second resin layer 12.

As in the case of the cylindrical body 15 of FIG. 3C, a carbon fiber 14 of the second resin layer 12 was oriented at 0 degrees, 45 degrees, and −45 degrees.

Polyamide 6 (PA6) was used as the thermoplastic resin of the third resin layer 13.

The thickness of the first resin layer 11 was 0.05 mm, the thickness of the second resin layer 12 was 2 mm, and the thickness of the third resin layer 13 was 1 mm.

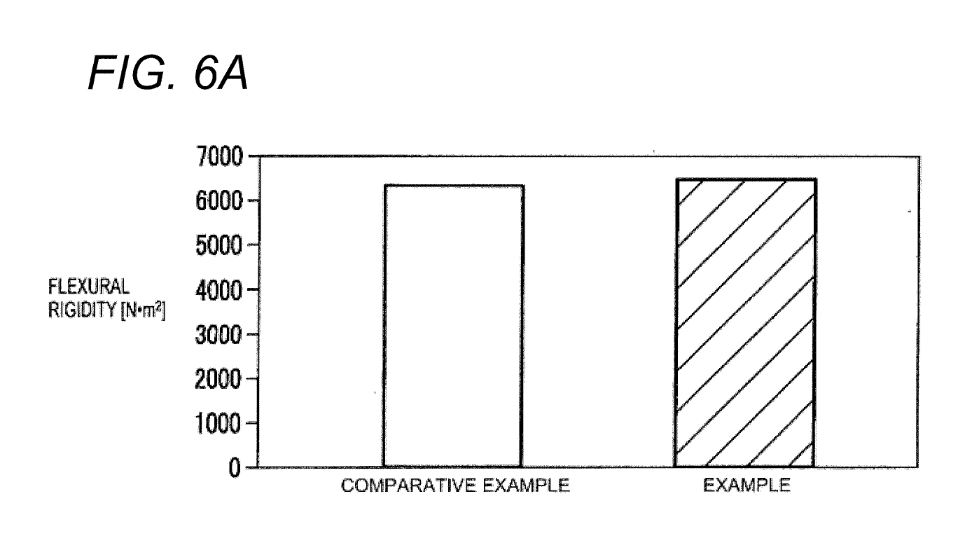

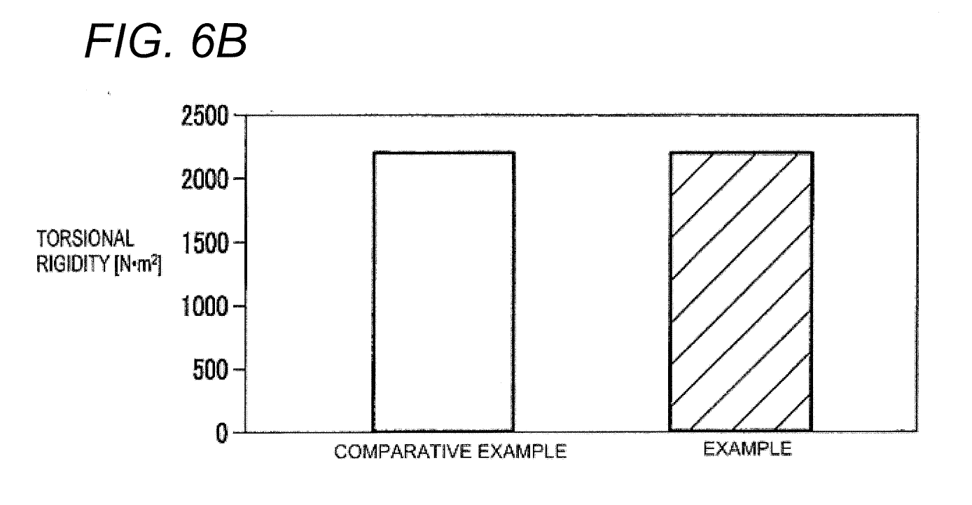

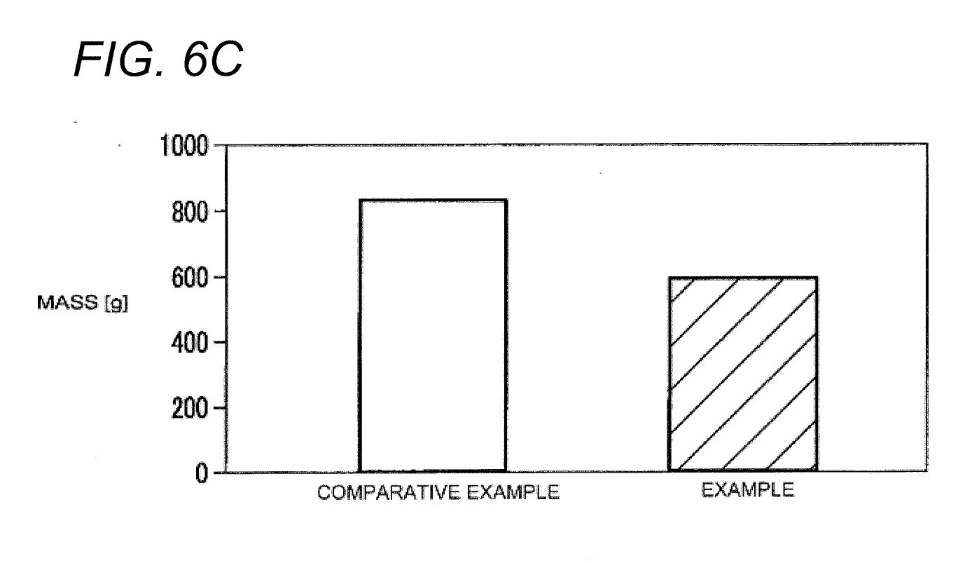

Next, experiments were performed to measure flexural rigidity, torsional rigidity, and mass of the created shaft. The experiment results are shown in FIGS. 6A to 60 as “Example.”

FIG. 6A is a graph showing the experiment result of flexural rigidity [N·m²], FIG. 6B is a graph showing the experiment result of torsional rigidity [N·m²], and FIG. 6C is a graph showing the measurement result of mass [g].

As shown in FIGS. 6A to 6C, the shaft as an example had a flexural rigidity of 6487 [N·m²], a torsional rigidity of 2200 [N·m²], and a mass of 592 [g].

Also, along with these measurement experiments, experiments were performed as in the case of the aforementioned shaft, to measure flexural rigidity [N·m²], torsional rigidity [N·m²], and mass [g] of a steel pipe having a 400 mm length, a 25 mm outer diameter, and a 13 mm inner diameter. The experiment results are shown in FIGS. 6A to 6C as “Comparative example.”

As shown in FIGS. 6A to 6C, the steel pipe as a comparative example had a flexural rigidity of 6331 [N·m²], a torsional rigidity of 2200 [N·m²], and a mass of 831 [g].

As indicated by the results of these measurement experiments, it has been verified that the shaft (the structural member of the vehicle) of the example has the same strength (flexural rigidity [N·m²], torsional rigidity [N·m²]) as the steel pipe (comparative example) formed into the same shape as the shaft of the example. It has also been verified that the mass of the shaft (the structural member of the vehicle) of the example is reduced by 29% from the steel pipe (comparative example).

Additionally, in the example, a structural member of a vehicle 10 (hereinafter referred to as sample 1) shown in FIG. 4A, and a structural member of a vehicle 10 (hereinafter referred to as sample 2) shown in FIG. 4B were created. Also, as a comparative example, a reference was created by omitting the first resin layer 11 from the structural member of the vehicle shown in FIG. 4A. That is, the reference was created by bonding the second resin layer 12 directly onto the base material 8. Note that polyether ether ketone (PEEK) was used as the thermoplastic resin of the first resin layer 11 and the second resin layer 12.

Next, the shear strength between the base material 8 and the second resin layer 12 was measured for each of sample 1, sample 2, and the reference.

The reference had a shear strength of 41.2 [MPa]. Meanwhile, sample 1 having the first resin layer 11 not containing the short carbon fiber 14a had a shear strength of 57.4 [MPa]. As is clear from this measurement result, it has been confirmed that since the structural member of the vehicle 10 according to the embodiment of the present invention has the first resin layer 11, it exerts stronger shear strength between the base material 8 and the second resin layer 12.

Additionally, sample 2 containing the short carbon fiber 14a in the first resin layer 11 had a shear strength of 62.0 [MPa]. It has been confirmed that since the structural member of vehicle 10 according to the embodiment of the present invention includes the short carbon fiber 14a in the first resin layer 11, it exerts even stronger shear strength between the base material 8 and the second resin layer 12.

According to a first aspect of the present invention, a structural member of a vehicle includes a metal base material and a resin layer containing thermoplastic resin and formed on the base material. The resin layer has a first resin layer and a second resin layer in this order from the base material side, and at least the second resin layer contains carbon fiber.

According to a second aspect of the present invention, a method of manufacturing the structural member of a vehicle includes: a first step of placing a first resin layer containing thermoplastic resin on a metal base material; a second step of placing a second resin layer containing carbon fiber and thermoplastic resin on the base material, with the first resin layer interposed therebetween; and a third step of bonding the second resin layer to the base material, by heating the thermoplastic resin contained in at least the first resin layer to a higher temperature than a glass-transition temperature.

The above aspects of the present invention can provide a structural member of a vehicle that has certain strength and is lighter than a member made only of metal, and a method of manufacturing the same.

Obviously, numerous modifications and variations of the present invention are possible in light of the above teachings. It is therefore to be understood that within the scope of the appended claims, the invention may be practiced otherwise than as specifically described herein.

What is claimed is:

1. A structural member of a vehicle, comprising:
a metal base material; and
a resin layer containing thermoplastic resin and formed on the base material, wherein:
the resin layer has a first resin layer and a second resin layer in this order from the base material side; and
at least the second resin layer contains carbon fiber.

2. A structural member of a vehicle, comprising:
a metal base material; and
a resin layer containing thermoplastic resin and formed on the base material, wherein
the resin layer contains carbon fiber oriented in one direction.

3. The structural member according to claim 1, wherein
the second resin layer contains carbon fiber oriented in one direction.

4. The structural member according to claim 1, wherein
the first resin layer further comprises randomly-oriented carbon fiber.

5. The structural member according to claim 1, wherein:
the base material is a tubular body; and
the resin layer is formed on an inner wall of the tubular body.

6. A method of manufacturing the structural member according to claim 1, comprising:
a first step of placing a first resin layer containing thermoplastic resin on a metal base material;
a second step of placing a second resin layer containing carbon fiber and thermoplastic resin on the base material, with the first resin layer interposed therebetween; and
a third step of bonding the second resin layer to the base material, by heating the thermoplastic resin contained in at least the first resin layer to a higher temperature than a glass-transition temperature.

7. The method of manufacturing the structural member according to claim 6, wherein
the third step is performed by applying a heating fluid having a predetermined pressure onto the second resin layer, while supporting the base material.

8. A structural member of a vehicle, comprising:
a metal body made of metal;
a first resin layer provided on the metal body in a layering direction and comprising a first thermoplastic resin; and
a second resin layer provided on the first resin layer in the layering direction and comprising a second thermoplastic resin and carbon fiber.

9. A structural member of a vehicle, comprising:
a metal body made of metal; and
a resin layer provided on the metal body and comprising a thermoplastic resin and carbon fiber oriented in one direction.

10. The structural member according to claim 8, wherein in the second resin layer the carbon fiber is oriented in one direction in the second resin layer.

11. The structural member according to claim 8, wherein the first resin layer further comprises randomly-oriented carbon fiber.

12. The structural member according to claim 8,
wherein the metal body is a tubular body; and
wherein the first resin layer is provided on an inner wall of the tubular body.

13. A method of manufacturing a structural member of a vehicle, comprising:
providing a first resin layer comprising a first thermoplastic resin on a metal body made of metal in a layering direction;
providing a second resin layer comprising carbon fiber and a second thermoplastic resin on the metal body via the first resin layer in the layering direction; and
heating the first thermoplastic resin to a temperature higher than a glass-transition temperature of the first thermoplastic resin to bond the second resin layer to the metal body.

14. The method of manufacturing the structural member, according to claim 13, wherein the first thermoplastic resin is heated by applying a heated fluid having a predetermined pressure onto the second resin layer with the metal body installed in a mold.

15. The structural member according to claim 8, wherein the first resin layer further comprises carbon fiber.

16. The method of manufacturing the structural member, according to claim 13, wherein the second thermoplastic resin is heated to the temperature higher than a glass-transition temperature of the second thermoplastic resin, when the first thermoplastic resin is heated to the temperature higher than the glass-transition temperature of the first thermoplastic resin.
